(19) United States
(12) Patent Application Publication
(10) Pub. No.: US 2023/0339255 A1
(43) Pub. Date: Oct. 26, 2023

(54) WRITING NIB ASSEMBLIES AND WRITING INSTRUMENTS

(71) Applicant: Sanford L.P., Atlanta, GA (US)

(72) Inventors: Helena B. HARRISON, Decatur, GA (US); Wing Sum Vincent KWAN, Alpharetta, GA (US)

(21) Appl. No.: 17/763,417

(22) PCT Filed: Sep. 29, 2020
(86) PCT No.: PCT/US2020/053280

§ 371 Date: Mar. 24, 2022

Related U.S. Application Data
(60) Provisional application No. 62/908,350, filed on Sep. 30, 2019.

(51) Int. Cl. B43K 8/06; B43K 1/12; C09D 11/17

(52) U.S. Cl. CPC B43K 8/06; B43K 1/12; C09D 11/17

(57) ABSTRACT

Writing nib assemblies and associated writing instruments are provided herein. Writing instruments are provided including a barrel having a barrel first end and an oppositely disposed barrel second end, an ink reservoir disposed within the barrel and containing an ink composition, a feeder rod disposed within the barrel and in fluid communication with the ink reservoir, a writing nib assembly disposed at least partially within the barrel and in fluid communication with the feeder rod, and a writing nib adapter disposed at least partially within the barrel and at least partially surrounding the writing nib assembly, wherein the writing nib adapter comprises at least one slot extending from an outer surface of the writing nib adapter to the inner surface of the writing nib adapter the slot being configured to allow for the passage of gas therethrough.

### CROSS-REFERENCE TO RELATED APPLICATIONS

This application claims priority benefit of U.S. Provisional Application No. 62/908,350, filed Sep. 30, 2019, which is incorporated by reference herein.

### FIELD OF THE DISCLOSURE

This disclosure relates to writing nib assemblies and writing instruments.

### BACKGROUND

Writing nib assemblies and writing instruments are known, however marker type writing instruments are often unsuitable for delivering certain types of ink. Specifically, many marker type writing instruments, particularly those having a fine writing tip, are easily clogged by inks which contain larger particles, such as metallic and glitter inks, and are thus unable to deliver these inks.

Accordingly, improved writing nib assemblies and writing instruments are needed.

### BRIEF DESCRIPTION OF THE DRAWINGS

The detailed description is set forth with reference to the drawings, which are meant to be exemplary and not limiting, illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

While certain figures may illustrate particular dimensions or relative dimensions of the components, it should be understood that these dimensions are merely exemplary and any suitable dimensions and relative dimensions may be used.

FIG. 1 illustrates the first end of a writing nib adapter, in accordance with the present disclosure.

FIG. 2 illustrates a side view of the writing nib adapter of FIG. 1.

FIG. 2A illustrates a cross-sectional view of the writing nib adapter, taken along line 2A-2A of FIG. 2.

FIG. 3 illustrates the second end of the writing nib adapter of FIG. 1.

FIG. 4 illustrates a perspective view of the nib adapter of FIG. 1.

FIG. 5 illustrates a perspective view of the nib adapter of FIG. 1.

FIG. 6 illustrates an end view of a writing nib assembly, in accordance with the present disclosure.

FIG. 7 illustrates a side view of the writing nib assembly of FIG. 6.

FIG. 8 illustrates a perspective view of the writing nib assembly of FIG. 6.

FIG. 9 illustrates a side view of a writing instrument including a writing nib adapter, a writing nib assembly, and a feeder rod, in accordance with the present disclosure.

FIG. 9A illustrates a cross-sectional view of the writing instrument of FIG. 9.

FIG. 10 illustrates a side view of a writing instrument including a writing nib adapter, a writing nib assembly, and a feeder rod, in accordance with the present disclosure.

FIG. 11 is a side view of a writing instrument, in accordance with the present disclosure.

FIG. 11A is a cross-sectional view of the writing instrument of FIG. 11, taken along line 11A-11A.

FIG. 12 illustrates an exploded view of the writing instrument of FIG. 11.

### SUMMARY

In one aspect, writing nib assemblies are provided. A writing nib assembly includes a writing nib that includes a first end configured to emit ink and a second end disposed opposite the first end, and a hollow nib collar configured to receive the writing nib and that includes a first end and a second end opposite the first end. The writing nib is disposed in the hollow nib collar such that the first end of the writing nib extends from the first end of the hollow nib collar and the second end of the writing nib extends from the second end of the hollow nib collar.

In another aspect, writing nib adapters are provided. A writing nib adapter includes a first hollow frustoconical portion having a first inner diameter at a first end and a second inner diameter at a second end, and a second substantially cylindrical portion having an outer surface, an inner surface, and an inner diameter substantially equal to the second inner diameter, wherein the first hollow frustoconical portion is configured to receive a writing nib assembly through the first end and is configured to receive a feeder rod through the second end, and wherein the substantially cylindrical portion has at least one slot extending from the outer surface of the substantially cylindrical portion to the inner surface of the substantially cylindrical portion, wherein the slot is configured to allow for the passage of gas therethrough to vent the passage of ink between the writing nib adapter and the writing nib assembly.

In yet another aspect, writing instruments are provided. A writing instrument, includes a barrel having a barrel first end and an oppositely disposed barrel second end, an ink reservoir disposed within the barrel and containing an ink composition, a feeder rod disposed within the barrel and in fluid communication with the ink reservoir, a writing nib assembly disposed at least partially within the barrel and in fluid communication with the feeder rod, and a writing nib adapter disposed at least partially within the barrel and at least partially surrounding the writing nib assembly, wherein the writing nib adapter has at least one slot extending from an outer surface of the writing nib adapter to the inner surface of the writing nib adapter the slot being configured to allow for the passage of gas therethrough to vent the passage of the ink composition between the writing nib adapter and the writing nib assembly, and wherein the feeder rod is formed of fibers resistant to solvent swelling.

In still yet another aspect, feeder rods are provided. A feeder rod includes a first end, configured for insertion into a second portion of a writing nib adapter, and configured to receive a writing nib, and a second end disposed opposite the first end and configured to receive an ink reservoir, wherein the feeder rod is formed of fibers resistant to solvent swelling.

### DETAILED DESCRIPTION

Writing nib assemblies and writing instruments have been developed. In some embodiments, writing nib assemblies are provided including a writing nib including a first end configured to emit ink, and a second end disposed opposite the first end; and a hollow nib collar configured to receive the writing nib and including: a first end, and a second end opposite the first end; wherein the writing nib is disposed in the hollow nib collar such that the first end of the writing nib extends from the first end of the hollow nib collar and the second end of the writing nib extends from the second end of the hollow nib collar.

In some embodiments, the writing nib is made from a plastic, such as an extruded plastic. In some embodiments, the writing nib is made from polyacetal. In some embodiments, the first end of the writing nib is substantially hemispherical. In some embodiments, the first end of the writing nib is frustoconical. In some embodiments, the second end of the writing nib includes an elliptical surface. Without intending to be bound by any particular theory, it is believed that plastic writing nibs may enable the nibs to deliver a very small writing linewidth, and provide resilience of the contact surface to allow the linewidth to be maintained at a constant and small level throughout the writing life of the marker, as compared to nibs made of softer materials, such as felt.

In some embodiments, the writing nib is made of a material that resists the solvents in the ink. That is, in some embodiments, the writing nib material is not damaged by and does not react with the solvents used in the ink. In some embodiments, the inks may be metallic inks, or glittery metallic inks. For example, in some embodiments, the inks may be of the forms described in any of U.S. Pat. Nos. 8,846,797; 9,163,153; 7,364,614; and 7,981,210, each of which is incorporated herein by reference.

In some embodiments, the ink includes a resin. In some embodiments, the resin may include a variety of synthetic resin emulsions, such as aqueous dispersions of polyacrylic acid esters, styrene-acrylate copolymers, polyvinyl acetate, ethylene-vinyl acetate copolymers, ethylene methacrylic acid copolymers, α-olefin-maleic acid copolymers, silicone resins, polyester and polyurethane, water-soluble resins such as polyvinyl alcohols, polyvinyl pyrrolidone and polyvinyl butyral, alkali-soluble resins such as styrene-maleic acid copolymers, ethylene-maleic acid copolymers and styrene-acrylate copolymers, oil-soluble resins such as ketone resins, ketone-formaldehyde resins, amide resins, alkyd resins, rosin-modified resins, rosin-modified phenol resins, phenol resins, xylene resins, polyvinyl pyrrolidone, α- and β-pinene-phenol polycondensation resins, polyvinyl butyral resins and acrylic resins.

In some embodiments, the resin is an acrylic resin. In some embodiments, the acrylic resin is a water-based acrylic resin, for example Joncryl® 67, Joncryl® 678, Joncryl® 682, Joncryl® 683, or combinations thereof, which are all available from BASF (Germany).

In some embodiments, the ink includes the resin in an amount of from about 0 wt. % to about 50 wt. %, for example about 0 wt. %, about 10 wt. %, about 20 wt. %, about 30 wt. %, about 40 wt. %, about 50 wt. %, and any ranges therebetween.

In some embodiments, the ink includes a solvent. In some embodiments, the solvent is water. In some embodiments, the solvent is one or more alcohols, for example, benzyl alcohol, ethanol, n-propanol, isopropanol, n-butanol, diacetone alcohol, or combinations thereof. In some embodiments, the solvent is a water-soluble organic solvent, for example, ethanol, propanol, butanol, glycerin, sorbitol, triethanolamine, diethanolamine, monoethanolamine, ethylene glycol, diethylene glycol, thiodiethylene glycol, polyethylene glycol, propylene glycol, butylene glycol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ethers propylene glycol monobutyl ether, ethylene glycol monomethyl ether acetate, sulfolane, 2-pyrrolidone, N-methyl-2-pyrrolidone and the like. In some embodiments, the solvent is an organic solvent, for example, naphtha, VM&P naphtha, refined solvent naphtha, petroleum sprit, xylene, methylisobutyl ketone, or butyl propionate.

In some embodiments, the ink includes shear-thinning imparting agents, for example, nonionic surfactants having a specific HLB value, xanthan gum, welan gum, succinoglycan (organic acid-modified heteroglycan composed of glucose unit and galactose unit, having an average molecular weight of about 100 to 8,000,000), guar gum, locust bean gum, hydroxyethyl cellulose, alkyl alginates, polymers mainly composed of alkyl methacrylate and having a molecular weight of 100,000 to 150,000, glycomannan, hydrocarbons having a gelling ability and extracted from seaweed such as agar or carrageenan, benzylidenesorbitol or derivatives thereof, crosslinking acrylic acid polymers and the like, hydrophobically-modified ethoxylated urethane (HEUR) thickeners, alkalai-swellable emulsion (ASE) thickeners, hydrophobically-modified alkali-swellable emulsion (HASE) thickeners, associative thickeners, and non-associative thickeners are used alone or mixed in combination.

In some embodiments, the ink includes other additives such as pigments, binders, viscosity modifiers, thixotropic agents, preservatives, lubricants, pH adjustors, antiseptics or fungicides, wetting agents, defoamers, dispersants, surfactants, humectants, biocides, and the like.

In some embodiments, the writing nib has a length of less than about 20 mm, less than about 10 mm, or less than about 2 mm. For example, in some embodiments the writing nib has a length of about 20 mm, about 19 mm, about 18 mm, about 17 mm, about 16 mm, about 15 mm, about 14 mm, about 13 mm, about 12 mm, about 11 mm, about 10 mm, about 9 mm, about 8 mm, about 7 mm, about 6 mm, about 5 mm, about 4 mm, about 3 mm, about 2 mm, about 1 mm, or any ranges therebetween. As used herein, the term “about” is used to refer to plus or minus 5 percent of the numerical value of the number with which it is being used.

In some embodiments, the writing nib includes ink channels having an average diameter of more than about 50 microns. For example, about 50 microns, about 60 microns, about 70 microns, about 80 microns, about 90 microns, about 100 microns, about 110 microns, about 120 microns, about 130 microns, about 140 microns, about 150 microns, about 160 microns, about 170 microns, about 180 microns, about 190 microns, about 200 microns, or any ranges therebetween.

In some embodiments, the hollow nib collar includes: a first substantially cylindrical portion at the first end of the hollow nib collar having a first diameter, a second substantially cylindrical portion at the second end of the hollow nib collar having a second diameter, and a third frustoconical portion extending between the first substantially cylindrical portion and the second substantially cylindrical portion. In some embodiments, the third frustoconical portion has a diameter at its largest end that is greater than the second diameter, such that the hollow nib collar may receive a writing nib adapter about the second substantially cylindrical portion that will not extend beyond the third frustoconical portion.

In some embodiments, writing nib adapters are provided including a first hollow frustoconical portion having a first inner diameter at a first end and a second inner diameter at a second end; and a second substantially cylindrical portion having an outer surface, an inner surface, and an inner diameter substantially equal to the second inner diameter, wherein the first hollow frustoconical portion is configured to receive a writing nib assembly through the first end and is configured to receive a feeder rod through the second end, and wherein the substantially cylindrical portion has at least one slot extending from the outer surface of the substantially cylindrical portion to the inner surface of the substantially cylindrical portion, wherein the slot is configured to allow for the passage of gas therethrough to vent the passage of ink between the writing nib adapter and the writing nib assembly.

In some embodiments, writing instruments are provided including a barrel having a barrel first end and an oppositely disposed barrel second end; an ink reservoir disposed within the barrel and containing an ink composition; a feeder rod disposed within the barrel and in fluid communication with the ink reservoir; a writing nib assembly disposed at least partially within the barrel and in fluid communication with the feeder rod; and a writing nib adapter disposed at least partially within the barrel and at least partially surrounding the writing nib assembly, wherein the writing nib adapter has at least one slot extending from an outer surface of the writing nib adapter to the inner surface of the writing nib adapter the slot being configured to allow for the passage of gas therethrough to vent the passage of the ink composition between the writing nib adapter and the writing nib assembly, and wherein the feeder rod is formed of fibers resistant to solvent swelling.

In some embodiments, the writing instrument further includes an end plug configured for mating engagement with the barrel second end. For example, the end plug may be configured for mating engagement with the barrel second end by a friction fit, snap fit, threads, and the like.

In some embodiments, the writing instrument further includes a cap configured for mating engagement with the barrel first end and covering the writing nib assembly. For example, the cap may be configured for mating engagement with the barrel first end by a friction fit, snap fit, threads, and the like.

In some embodiments, the ink composition includes particles having a diameter of at least about 0.5 microns, at least about 2 microns, at least about 5 microns, at least about 10 microns, or at least about 20 microns. For example, in some embodiments, the ink composition includes particles having a diameter of about 0.5 microns, about 0.6 microns, about 0.7 microns, about 0.8 microns, about 0.9 microns, about 1 microns, about 2 microns, about 3 microns, about 4 microns, about 5 microns, about 10 microns, about 20 microns, about 30 microns, about 40 microns, about 50 microns, about 60 microns, about 70 microns, about 80 microns, or any ranges therebetween.

In some embodiments, the writing instrument can deliver an ink mark immediately after being subjected to an ISTA 1A test. For example, in some embodiments, the instrument can deliver an ink mark having a line intensity of 3 immediately after being subjected to an ISTA 1A test.

In some embodiments, feeder rods are provided including a first end, configured for insertion into a second portion of a writing nib adapter, and configured to receive a writing nib; and a second end disposed opposite the first end and configured to receive an ink reservoir, wherein the feeder rod is formed of fibers resistant to solvent swelling. Without intending to be bound by any particular theory, it is believed that the feeder rod helps to reduce clogging of the writing nib by acting as a buffer to reduce the speed at which ink enters the writing nib, as compared to reservoir systems without a feeder rod.

In some embodiments, the fibers of the feeder rod include acrylic acid, polyester, cellulose, nylon, or any combinations thereof. In some embodiments, the fibers of the feeder rod have a diameter of at least about 5 denier or at least about 7 denier, for example about 5 denier, about 6 denier, about 7 denier, about 8 denier, about 9 denier, about 10 denier, about 11 denier, about 12 denier, about 13 denier, about 14 denier, about 15 denier, about 16 denier, about 17 denier, abut 18 denier, about 19 denier, about 20 denier, or any ranges therebetween.

In some embodiments, the feeder rod has a diameter of less than about 6 mm, for example about 5 mm, about 4 mm, about 3 mm, about 2 mm, about 1 mm, or any ranges therebetween. In some embodiments, the feeder rod has a length of less than about 40 mm, for example about 40 mm, about 35 mm, about 30 mm, about 25 mm, about 20 mm, about 15 mm, about 10 mm, or any ranges therebetween.

### Illustrated Embodiments

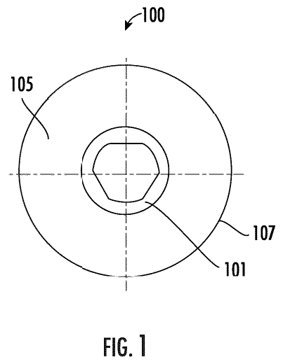

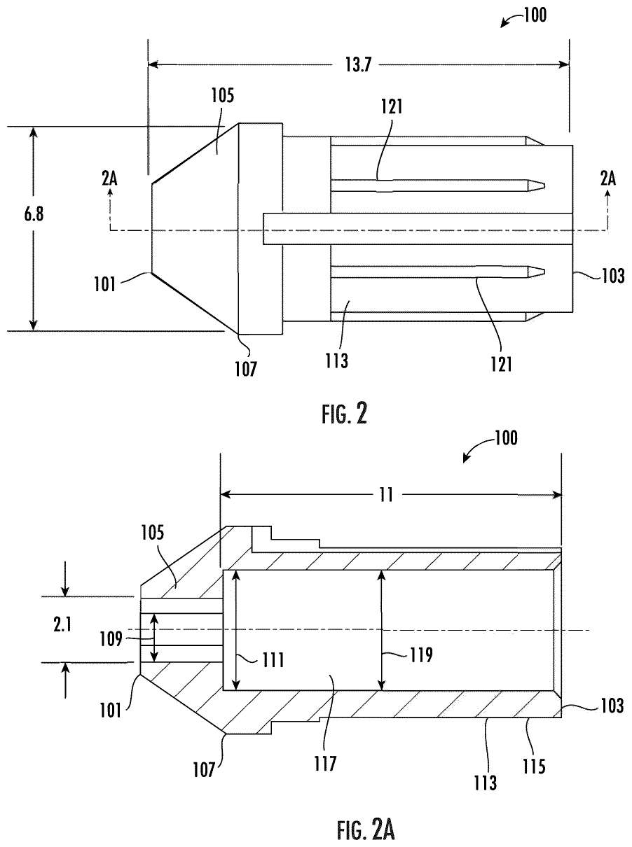

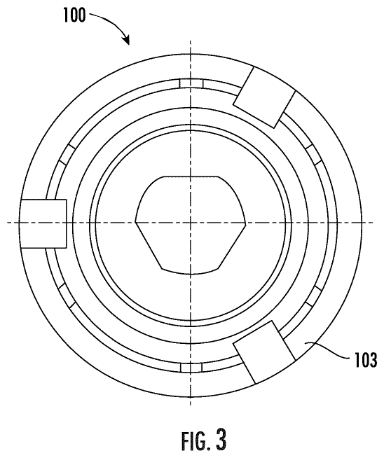

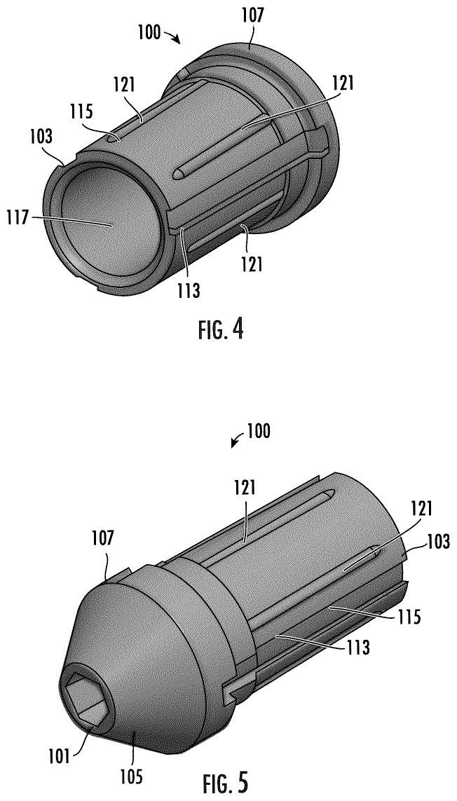

FIGS. 1-5 illustrate various views of a writing nib adapter 100 according to an embodiment of the present disclosure. The writing nib adapter 100 includes a first end 101 and a second end 103, opposite the first end. FIG. 1 illustrates a view of the writing nib adapter 100 from the first end. FIG. 2 illustrates a side view of the writing nib adapter 100. FIG. 2A illustrates a cross-sectional view of FIG. 2, taken along the line 2A-2A. FIG. 3 illustrates a view of the writing nib adapter 100 from the second end. FIGS. 4 and 5 are perspective views.

The writing nib adapter 100 includes a first hollow frustoconical portion 105 having a first end 101 and a second end 107. As can be seen from FIG. 2A, the writing nib adapter 100 has a first inner diameter 109 at the first end 101 and a second inner diameter 111 at a second end 107. The writing nib adapter 100 further includes a second substantially cylindrical portion 113 having an outer surface 115, an inner surface 117, and an inner diameter 119 which is substantially equal to the second inner diameter 111. The first hollow frustoconical portion 105 is configured to receive a writing nib assembly through the first end 101, and is configured to receive a feeder rod through the second end 103. The substantially cylindrical portion 113 further includes a plurality of vent slots 121 which are configured to allow for the passage of gas therethrough to vent the passage of ink between the writing nib adapter 100 and a writing nib assembly.

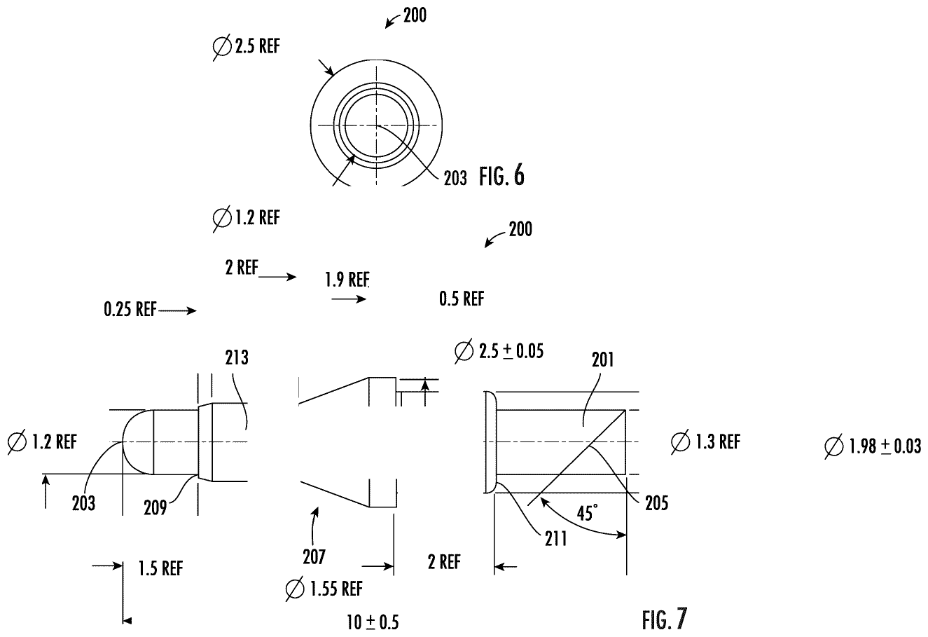

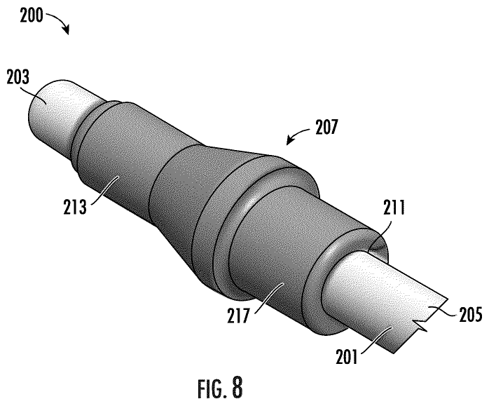

FIGS. 6-8 illustrate various views of a writing nib assembly 200 according to embodiments of the present disclosure. The writing nib assembly 200 includes a writing nib 201 including a first end 203 that is configured to emit ink, and a second end 205 opposite the first end 203. The first end 203 is substantially hemispherical. The second end 205 of the writing nib is cut at an angle, such that the second end 205 includes an elliptical surface. The writing nib assembly 200 further includes a hollow nib collar 207, having a first end 209 and a second end 211 opposite the first end 209. The hollow nib collar 207 further includes a first substantially cylindrical portion 213 at the first end 209 of the hollow nib collar 207 having a first diameter 215, a second substantially cylindrical portion 217 at the second end 211 of the hollow nib collar 207 having a second diameter 219, and a third frustoconical portion 221 extending between the first substantially cylindrical portion 213 and the second substantially cylindrical portion 217. The third frustoconical portion 221 has a diameter at its largest end that is greater than the second diameter, such that the hollow nib collar 207 may receive a writing nib adapter 100 about the second substantially cylindrical portion 217 that will not extend beyond the third frustoconical portion 221.

The writing nib 201 is further disposed in a hollow nib collar 207, such that the first end 203 of the writing nib 201 extends from the first end 209 of the hollow nib collar and the second end 205 of the writing nib extends from the second end 211 of the hollow nib collar 207.

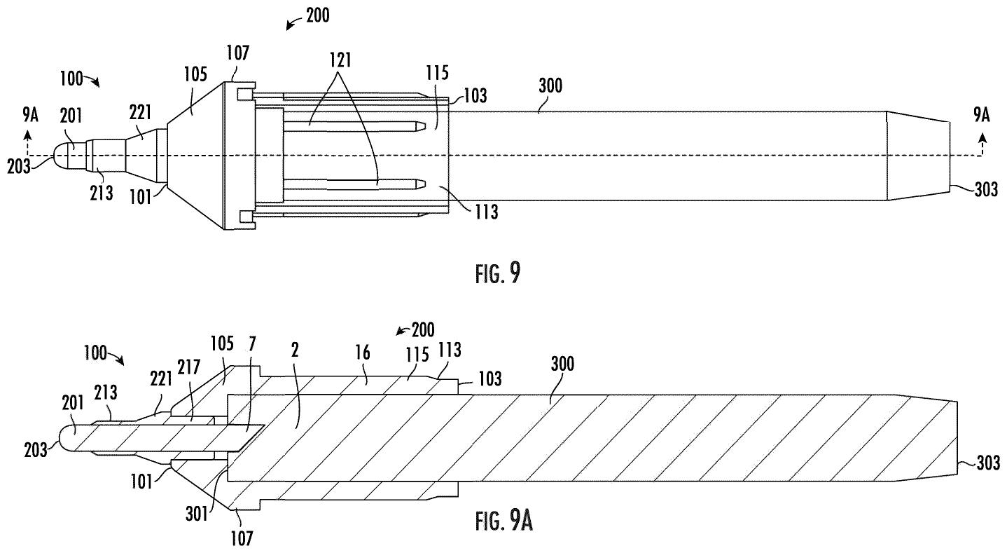

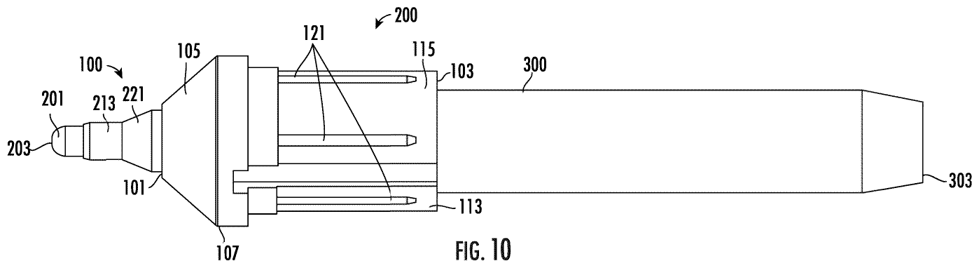

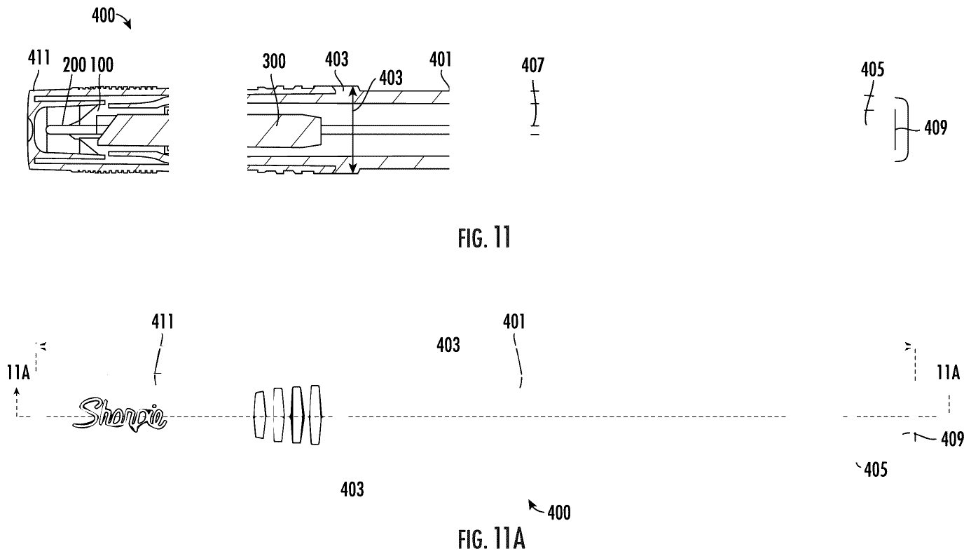

FIGS. 9-10 illustrate partial views of a writing instrument including a writing nib adapter 100, a writing nib assembly 200, and a feeder rod 300. FIG. 9A illustrates a cross-section of FIG. 9, taken along the line 9A-9A. The feeder rod 300 includes a first end 301, configured for insertion into the second end 107 of the writing nib adapter 100, and to receive a writing nib 201. The feeder rod 300 further includes a second end 303, disposed opposite the first end 301 and configured to receive an ink reservoir.

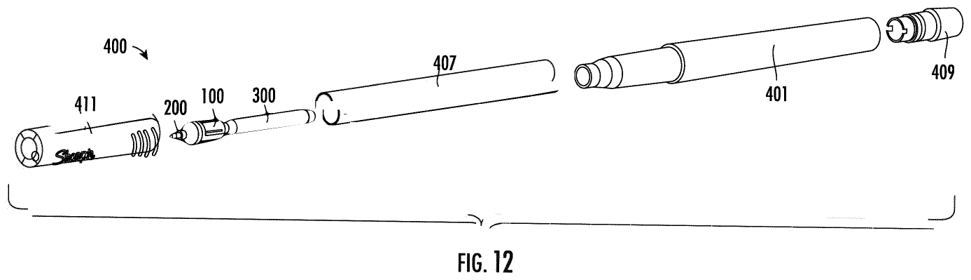

FIGS. 11-12 illustrate various views of a writing instrument 400 according to an embodiment of the present disclosure. FIG. 11 illustrates a side view of a writing instrument 400, FIG. 11A is a cross-sectional view of FIG. 11 taken along line 11A-11A, and FIG. 12 illustrates an exploded view of the writing instrument of FIGS. 11 and 11A. The writing instrument 400 includes a barrel 401 having a barrel first end 403 and an oppositely disposed barrel second end 405, having a barrel second end width 404. An ink reservoir 407 is disposed within the barrel 401. The writing instrument 400 further includes a feeder rod 300 in fluid communication with the ink reservoir 407, and a writing nib assembly 200 disposed at least partially within the barrel 401 and in fluid communication with the feeder rod 300, and a writing nib adapter 100 disposed at least partially within the barrel 401 and at least partially surrounding the nib assembly 200. The writing instrument 400 further includes an end plug 409, which is configured for mating engagement with the barrel second end 405, and a cap 411 configured for mating engagement with the barrel first end 403, and for covering the writing nib assembly 200, such that the writing instrument 400 has length 402.

### EXAMPLES

Embodiments of the present disclosure may be better understood by reference to the following example.

### Example 1: Writing Performance and Vibration Tests

Two writing instruments were prepared, each containing gold metallic ink (available from Sanford LP, Atlanta, Georgia) as described in U.S. Pat. No. 8,846,797. A first writing instrument was prepared according to the present disclosure, including a plastic writing nib, a feeder rod, and a reservoir. The plastic nib was a polyacetyl nib with an outer dimension of 1.2 mm and a length of 8.4 mm. The feeder rod was made of acrylic fiber with a length of 30.5 mm and diameter of 3.5 mm. The reservoir was made with polyester fiber (4.4 dpf) and had a diameter of 5.0 mm and a length of 78.0 mm.

A second writing instrument was prepared without a feeder rod. The plastic nib of this second writing instrument was a polyacetyl nib with an outer dimension of 1.2 mm and a length of 25 mm. The reservoir as made with polyester fiber (4.4 dpf) and a diameter of 7.8 mm and a length of 93.2 mm. Both writing instruments were subjected to an ISTA 1A test (14,000 impacts at a frequency of 200 impacts per minute). The results of these tests are shown in Table 1 below:

TABLE 1
Writing Properties

| | First Writing | Second Writing |
|---|---|---|
| Writing Property | Instrument | Instrument |
| Ability for | Immediate | No mark was produced |
| the marker to | | in usage upon completion |
| deliver a mark | | of the test |
| Line intensity | 3 | 0 |
| (3- highest, 0- | | |
| none) | | |

It will be apparent to those skilled in the art that various modifications and variations can be made to the present disclosure without departing from the spirit and scope of embodiments of the disclosure. Thus, it is intended that the described embodiments cover the modifications and variations of the disclosure provided they come within the scope of the appended claims and their equivalents.

What is claimed is:

1. A writing instrument, comprising:
a writing nib assembly, comprising;
a writing nib, comprising:
a first end configured to emit ink, and
a second end disposed opposite the first end; and
a hollow nib collar configured to receive the writing nib and comprising:
a first end, and
a second end opposite the first end;
wherein the writing nib is disposed in the hollow nib collar such that the first end of the writing nib extends from the first end of the hollow nib collar and the second end of the writing nib extends from the second end of the hollow nib collar; and
a writing nib adapter comprising:
a hollow frustoconical portion having a first inner diameter at a first end and a second inner diameter at a second end; and
a substantially cylindrical portion having an outer surface, an inner surface, and an inner diameter substantially equal to the second inner diameter;
wherein the hollow nib collar is configured to receive the writing nib adapter, and the hollow frustoconical portion is configured to receive the writing nib assembly through the first end and a feeder rod through the second end.

2-4. (canceled)

5. The writing instrument of claim 1, wherein the second end of the writing nib comprises an elliptical surface.

6-10. (canceled)

11. The writing instrument of claim 1, wherein the hollow nib collar comprises:
a first substantially cylindrical portion at the first end of the hollow nib collar having a first diameter,
a second substantially cylindrical portion at the second end of the hollow nib collar having a second diameter, and
a frustoconical portion extending between the first substantially cylindrical portion and the second substantially cylindrical portion.

12. The writing instrument of claim 11, wherein the frustoconical portion has a diameter at its largest end which is greater than the second diameter, such that the hollow nib collar may receive the writing nib adapter about the second substantially cylindrical portion which will not extend beyond the frustoconical portion.

13. (canceled)

14. A writing instrument, comprising:
a barrel having a barrel first end and an oppositely disposed barrel second end;
an ink reservoir disposed within the barrel and containing an ink composition;
a feeder rod disposed within the barrel and in fluid communication with the ink reservoir;
a writing nib assembly disposed at least partially within the barrel and in fluid communication with the feeder rod; and
a writing nib adapter disposed at least partially within the barrel and at least partially surrounding the writing nib assembly,
wherein the writing nib adapter comprises at least one slot extending from an outer surface of the writing nib adapter to the inner surface of the writing nib adapter the slot being configured to allow for the passage of gas therethrough to vent the passage of the ink composition between the writing nib adapter and the writing nib assembly, and wherein the feeder rod comprises fibers resistant to solvent swelling.

15. The writing instrument of claim 14, further comprising an end plug configured for mating engagement with the barrel second end.

16. The writing instrument of claim 14, further comprising a cap configured for mating engagement with the barrel first end and covering the writing nib assembly.

17. The writing instrument of claim 14, wherein the ink composition comprises particles having a diameter of at least about 0.5 microns.

18. The writing instrument of claim 14, wherein the ink composition comprises particles having a diameter of at least about 2 microns.

19. The writing instrument of claim 14, wherein the ink composition comprises particles having a diameter of at least about 5 microns.

20. The writing instrument of claim 14, wherein the ink composition comprises particles with a diameter of at least about 10 microns.

21. The writing instrument of claim 14, wherein the ink composition comprises particles having a diameter of at least about 20 microns.

22. The writing instrument of claim 17, wherein the instrument can deliver an ink mark immediately after being subjected to an ISTA 1A test.

23. The writing instrument of claim 22, wherein the instrument can deliver an ink mark having a line intensity of 3 immediately after being subjected to an ISTA 1A test.

24. A feeder rod, comprising:
a first end, configured for insertion into a second portion of a writing nib adapter, and configured to receive a writing nib; and
a second end disposed opposite the first end and configured to receive an ink reservoir,
wherein the feeder rod comprises fibers resistant to solvent swelling.

25. The feeder rod of claim 24, wherein the fibers comprise acrylic acid, polyester, cellulose, nylon, or any combinations thereof.

26. The feeder rod of claim 24, wherein the fibers have a diameter of at least about 5 denier.

27. (canceled)

28. The feeder rod of claim 24, wherein the feeder rod has a diameter of less than about 6 mm.

29. The feeder rod of claim 24, wherein the feeder rod has a length of less than 40 mm.

30. The writing instrument of claim 1, wherein the substantially cylindrical portion comprises at least one slot extending from the outer surface of the substantially cylindrical portion to the inner surface of the substantially cylindrical portion, wherein the at least one slot is configured to allow for the passage of gas therethrough to vent the passage of ink between the writing nib adapter and the writing nib assembly
